(19) United States
(12) Patent Application Publication
(10) Pub. No.: US 2008/0206545 A1
(43) Pub. Date: Aug. 28, 2008

(54) Porous material and method for preparing the same

(75) Inventors: Yu Cheng Chang, Taipei County (TW); Jing Lyang Jeng, Hsinchu County (TW); Kun Cheng Lin, Hsinchu County (TW); Te Yu Wei, Taipei County (TW); Shih Yuan Lu, Hsinchu (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu Hsien (TW)

(21) Appl. No.: 11/979,394

(22) Filed: Nov. 2, 2007

(30) Foreign Application Priority Data
Feb. 26, 2007 (TW) 96106452

(51) Int. Cl. B32B 3/26; C08J 9/26

(52) U.S. Cl. 428/312.6; 521/63

(57) ABSTRACT

The present invention is related to a porous structure material, which is synthesized by mixing an alkyl siloxane compound or a silicate compound with an organic solvent through a sol-gel process, and modified by modification agents. The present invention is also related to a method for manufacturing porous structure material, which comprises reacting an alkyl siloxane compound or a silicate compound with an organic solvent through sol-gel process. The present invention utilizes modification agents to modify hydrophilic groups into hydrophobic groups on the surface of the porous structure material, thereby to lower the surface tension and maintain the porous structure. The porous structure material of the present invention has properties of low conductive coefficient, high porosity, high hydrophobicity and self-cleaning.

### BACKGROUND OF THE INVENTION

1. Field of the invention

The present invention is related to a porous structure material comprising an alkyl siloxane, and to a method for preparing said material, especially for utilizing modifying agents to modify hydrophilic groups into hydrophobic groups on the surface of said porous structure material, thereby to lower the surface tension, thermal conductive coefficient and density, to enhance the porosity, and to produce a material having high heat insulating property.

2. Description of the related art

The porous material of silica aerogel has the same chemical components as glass, and said material has advantages such as low density, low refractive index, high BET surface area, small pore size, and within the visible light spectrum. Such material has obvious commercial value to be applied in associated technologies, such as glass bulk material and optic fiber derived from gel, solar energy storage system, heat preservation system of furnace, heat preservation tube, filling material, radioluminescence and power system, the catalysis and filtration of polluted air/water, and transparent/opaque heat insulating material, thereby can improve the energy saving and enhance economic value in light of energy shortage.

The preparation of the above-mentioned aerogel mainly comprises: homogenously mixing an alkyl siloxane or a silicate with various solvents, drying, and then producing a porous network nano-structure material having low density and low thermal conductive coefficient. A porous material of having nano pores, which is produced by silica aerogel, has extreme low material density because air occupies 80% and more of the volume in the three-dimensional network structure of said aerogel. The aerogel itself is transparent or semi-transparent, and it has excellent heat insulating effect because the air having refractive index of 1 occupies most volume of the aerogel, and thereby said aerogel has particular properties such as light weight, low refractive index and low thermal conductive coefficient.

However, if the aerogel is synthesized through sol-gel process, it is known that the aerogel will be broken by the contraction resulted from high surface tension, in which the surface tension is produced by hydrophilic groups —OH when the aerogel contacts the air and the ambient pressure drying is proceeded; therefore, the network structure inside the dried aerogel will be collapsed, the aerogel itself will be broken, and the aerogel will lose the advantage from low thermal conductive coefficient. Since then, it will be obviously advantageous if we can find a method for lowering the high surface tension of the aerogel because the gel contraction, thermal conductive coefficient, density of the aerogel, and enhancing the porosity of said gel will be decreased.

### SUMMARY OF THE INVENTION

The materials having high insulating property cannot be produced by the conventional aerogel preparation process because the structure of said material often collapses, which resulted from the contraction of framework and the surface tension of the nano pores within the gel during the drying step, and thereby the thermal conductive coefficient increases. Therefore, one object of the present invention is to provide a porous structure material synthesized by mixing an alkyl siloxane compound or a silicate compound with an organic solvent through a sol-gel process, and the hydrophilic groups located on the surface of the porous structure material are modified into hydrophobic groups by modification agents. The porous structure material will not absorb the water in the air easily, so the damage of the porous structure will be avoided, and the disadvantages of the conventional porous material caused by extreme high surface tension, e.g. high density, high thermal conductive coefficient, low porosity, and low hydrophobicity, will be overcome.

Another object of the present invention is to provide a method for manufacturing a porous structure material, which is used for preparing a porous structure material having low density, low thermal conductive coefficient, high porosity, high hydrophobicity and the like.

Yet another object of the present invention is to provide an applicable material having low density and low thermal conductive coefficient, which is used for coating agent, filling material, and heat insulating material.

To achieve the above mentioned objects, the present invention provides a porous structure material synthesized by mixing an alkyl siloxane compound or a silicate compound with an organic solvent through a sol-gel process, and modified by modification agents; wherein said modification agents comprises a mixture of trimethylchlorosilane/n-hexane or a mixture of dimethylchlorosilane/n-hexane, and said porous structure material has average thermal conductive coefficient of 0.04 W/m-K to 0.02 W/m-K. The surface of said porous structure material comprises hydrophobic groups.

In some preferred embodiments, the mixing ratio of the alkyl siloxane compound or the silicate compound to the organic solvent is 1:6 to 1:10.

In some preferred embodiments, the bulk density of said porous structure material is higher than 0.069 g/cm³, and the porosity of it is higher than 95%.

Also, the present invention provides a method for manufacturing a porous structure material, which comprises: (a) mixing an alkyl siloxane compound or a silicate compound with an organic solvent; (b) adding acidic catalyst to proceed hydrolysis reaction; (c) adding basic catalyst to proceed condensation reaction, and forming a sol; (d) washing said sol by a solvent; (e) exchanging the solvent within said sol with an organic solvent; (f) adding modification agents to modify the surface of said sol, in which said modification agents comprise a mixture of trimethylchlorosilane/n-hexane or a mixture of dimethylchlorosilane/n-hexane; (g) removing the modification agents within said sol; and (h) drying the sol in step (g) to produce a porous structure material.

In some preferred embodiments, the alkyl siloxane compound in step (a) comprises tetraethoxysilane or tetramethoxysilane; the organic solvent in step (a) comprises anhydrous ethanol, isopropanol, acetone, methanol, formamide, or ethylene glycol; and the mixing ratio of the alkyl siloxane compound or the silicate compound to the organic solvent in step (a) is 1:6 to 1:10.

In some preferred embodiments, the acidic catalyst in step (b) comprises hydrochloric acid, nitric acid, or oxalic acid.

In some preferred embodiments, the basic catalyst in step (c) comprises ammonium hydroxide.

In some preferred embodiments, the solvent in step (d) comprises ethanol, isopropanol, acetone, methanol, formamide, or ethylene glycol.

In some preferred embodiments, the organic solvent in step (e) comprises n-hexane or heptane.

The present invention also provides an applicable material comprising said porous structure material, which is used for coating agent, filling material, and heat insulating material.

In some preferred embodiments, said applicable material has bulk density of higher than 0.069 g/cm³, porosity of higher than 95%, and average thermal conductive coefficient of 0.04 W/m-K to 0.02 W/m-K.

By adding modification agents, the present invention can modify the hydrophilic groups on the surface of the gel into hydrophobic groups and lower the surface tension, and thereby the gel can maintain its complete network structure during the drying step. The porous structure material manufactured by the present invention has low density, low thermal conductive coefficient, high porosity, high hydrophobicity, and other advantages that the material produced by the conventional producing method cannot have.

### BRIEF DESCRIPTION OF THE DRAWINGS

FIG. 1 is the diagram illustrating the principle of the present invention.

FIG. 2 is the flow chart of the porous aerogel preparation described in example 1 of the present invention.

FIG. 3 is the IR spectrum of the porous aerogels described in example 2 of the present invention.

FIG. 4 is the electro-microscopic photo of the modified porous aerogel described in example 2 of the present invention.

FIG. 5 is the diagrams illustrating the contact angles of the modified porous aerogels described in example 2 of the present invention; wherein (A) is single-modified porous aerogel, and (B) is multiple-modified porous aerogel.

### DETAILED DESCRIPTION OF THE PREFERRED EMBODIMENTS

In conventional aerogel preparation, the surface of the gel is usually hydrophilic, as shown in the following formula (I); therefore, when said gel contact the air, it will absorb the water in the air, thereby damage the porous structure of the gel, lower the insulating property, and result in inability to use for a long time, and lack of weatherability and continuous usability. In addition, when the ambient temperature is extreme high, the thermal conductive coefficient of the aerogel will result in the steep decrease in insulating effect, so the gel cannot be used under high temperature.

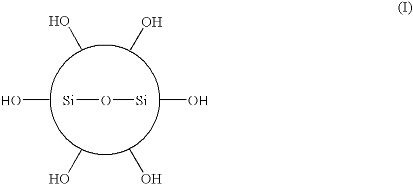

Generally speaking, the functional groups on the surface of the aerogel prepared by alkyl siloxane or silicate are mainly —OH groups. When such hydrophilic groups contact with the air, the aerogel will be broken by the contraction resulted from high surface tension. Therefore, in order to proceed the drying step under normal pressure, the inventor have done some research and found that the surface modification technology can modify the hydrophilic groups on the surface of the wet gel into hydrophobic groups, and dramatically decrease the effect of surface tension, thereby the dried aerogel can still maintain its complete three-dimensional network structure.

The surface modification agents for general use are trimethylchlorosilane (TMCS) and dimethylchlorosilane. The —OH groups on the surface of the aerogel will react with the —Cl groups of modification agents and produce hydrochloric acid, thereby the H of said —OH groups will be replaced, that is, the —OH groups are modified to hydrophobic —OSi(CH₃)₃ groups, as shown in the following formula:

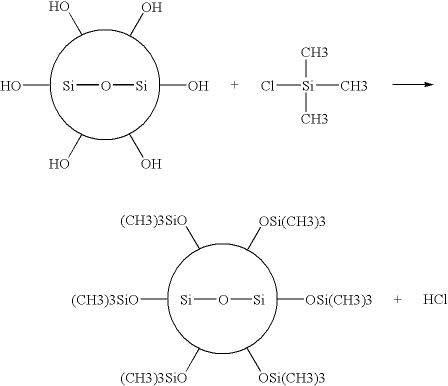

In addition, the thermal conductive coefficient of the aerogel having finely solid network structure can be represented by the following formula:

k′ₛ=ρ′·ν′·[kₛ/(ρₛ·νₛ)]

In said formula, ρ′ and ρₛ represent the density of each gel and the bulk density of the solid respectively; ν′ and νₛ represent the longitudinal sound velocity of each gel and the sound velocity of the solid; κₛ is the thermal conductive coefficient of the solid.

To the solid thermal conductive coefficient of the material having full density and being formed the network structure, k′ₛ, the main variants are ρₛ, νₛ, κₛ. The ratio kₛ/(ρₛ·νₛ) will change according to the selection of aerogel material. If the lower k′ₛ is desired, choosing an aerogel having high density, low thermal conductive coefficient, and high sound velocity is necessary.

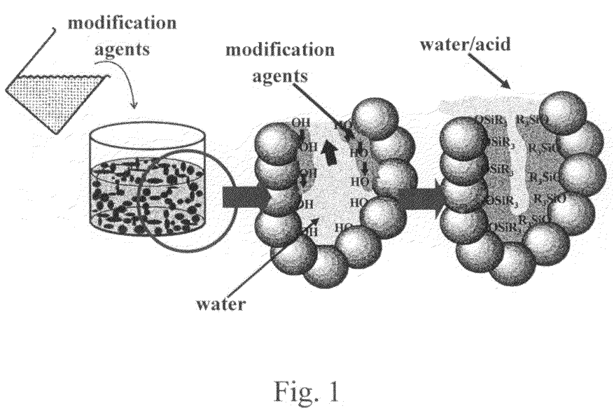

The present invention is characterized by homogeneously dispersing the gel particles in a solution by an alkyl silicone during the stage of sol; maintaining the relative activity of the particles; and making them to polymerize to a gel having larger molecular weight; catalyzing the gel to a wet gel by various catalysts; and then drying to leave an aerogel insulating material having low density, low thermal conductive coefficient, and a porous network nano structure. (See FIG. 1)

The following Examples are provided to specifically describe the technical features of the present invention, but these Examples are not used to limit this invention, and various alterations and modifications can be made by those skilled in the art without departing from the spirit and the scope of this invention.

### EXAMPLES

### Example 1,

### Preparing of a Modified Porous Aerogel

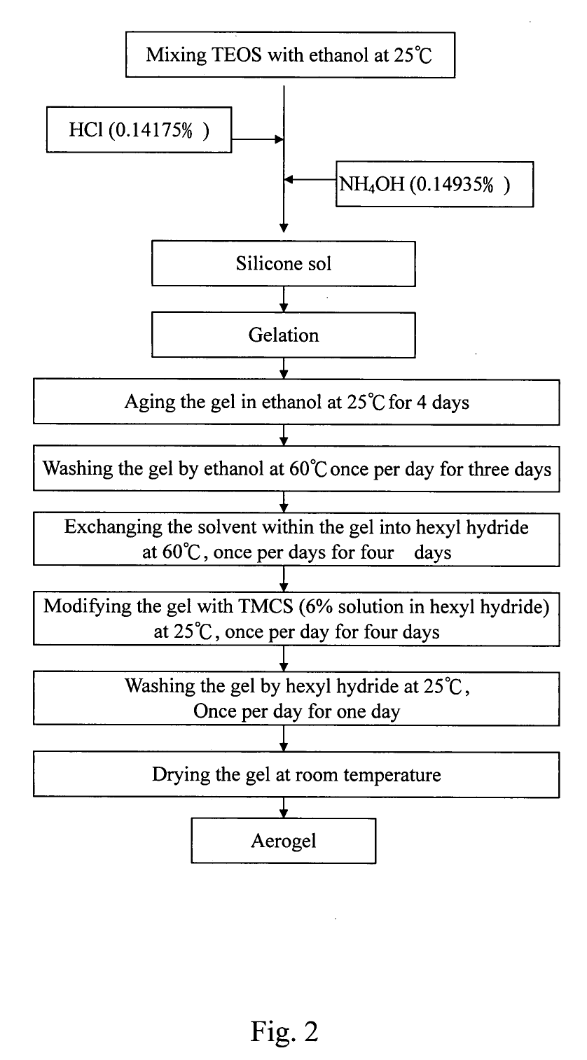

This example is to produce an aerogel insulating material having a porous network nano structure, and the flow chart of this preparation is shown in FIG. 2. First, by sol-gel process, mixing a precursor material and an organic solvent; adding acidic catalyst to proceed hydrolysis reaction; adding basic catalyst to proceed condensation reaction, and forming a sol. The sol is extreme small gel particles, and said gel particles are homogeneously dispersed in the solution. Next, the molecules with in the sol will be further condensed to produce bonds, and form a semi-solid high molecular gel. After aging for a period of time, said gel will form a stable three-dimensional network structure.

The precursor material of this example is tetraethoxysilane (TEOS). To proceed the hydrolysis and condensation reactions through sol-gel process, tetraethoxysilane, anhydrous ethanol, and deionized water are used as the sol body, and hydrochloric acid and ammonia are used as acidic catalyst and basic catalyst respectively. The mixing process in two separate stages (referring to FIG. 2, adding HCl and NH₄OH), and each homogeneously mix 120 minutes, finally to form a sol.

Then the sol is sealed and static tested at room temperature (25° C.) to proceed gelation. After four-day aging, a wet gel is formed. After that, the wet gel is washed by high purity ethanol (99%) at 60° C. once a day for three days.

Subsequently, the static solvent within the gel is exchanged with n-hexane at 60° C. for four times, each time for 24 hours (one day). The modification agents, trimethylchlorosilane (TMSC) and n-hexane, are prepared by solving 6% TMSC in n-hexane, and the wet gel modification is proceeded statically at 25° C. for four times, each time for 24 hours (one day). After the static modification, the gel is washed at 25° C. by n-hexane for four times, each time for 24 hours (one day), to remove the modification solvent within the modified gel. At last, the wet gel is dried for 96 hours under room temperature and normal pressure, to produce a heat insulating aerogel material having a porous network nano structure.

Notice should be added that the modification steps described above is single-modification process, and single-modification repeated several times means multiple-modification.

In this example, there is another experiment group which process multiple-modification and the difference between single-modification and multiple-modification is the number of times for modification. In single-modification, the gel is soaked in the modification agents for 24 hours, and then washed. In multiple-modification, the gel is soaked in the modification agents for 24 hours and the reaction balance is reached, then more fresh modification agents are added, and the modification step is repeating to reach complete surface modification, that is, all silica particles within the holes are modified to hydrophobic. The illustrative structure of the modified porous aerogel according to this example is as following:

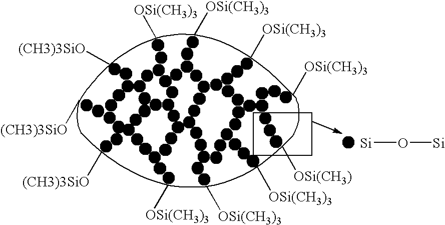

wherein the ratio of Si—O—Si to OSi(CH₃)₃ is approximately 1:4.

The skilled in the art can change various control parameters including the molar ratio of reactants, acidic catalyst, basic catalyst, reaction temperature, molar content of the solvents, stirring speed, mixing time, modification agents, pH, drying time, and the like to proceed the sol-gel process.

### Example 2

### Testing Characteristics of the Porous Aerogel

In this Example, the density, porosity, volume shrinkage, thermal conductive coefficient, BET surface area, average pore size, and average pore volume of the unmodified gel and the modified gels according to Example 1 are tested, and the structure and components of said gels are observed by IR and electro-microscopy. The tests of the present invention are proceeded according to the dead volume method developed in Japan, which is used as a pore structure analyzing method for porous materials.

The characteristics of the unmodified gel and the modified gels according to Example 1 are shown in Table 1. From these results, after multiple-modification, the density of the aerogel decreases to about 0.069 g/cm³, the porosity increases to about 97%, the BET surface area increases, the total pore volume increases obviously, and the average pore size also become larger.

TABLE 1

| | Density | | BET surface | Total pore | Average pore |
|---|---|---|---|---|---|
| Item | (g/cm³) | Porosity (%) | area (m²/g) | volume (cm³/g) | size (nm) |
| Unmodified | 0.624 | 72 | 644 | 0.58 | 3.6 |
| Gel | | | | | |
| Single- | 0.502 | 77 | 690 | 0.98 | 4.7 |
| Modified Gel | | | | | |
| Multiple- | 0.069 | 97 | 781.86 | 1.23 | 6.3 |
| Modified Gel | | | | | |

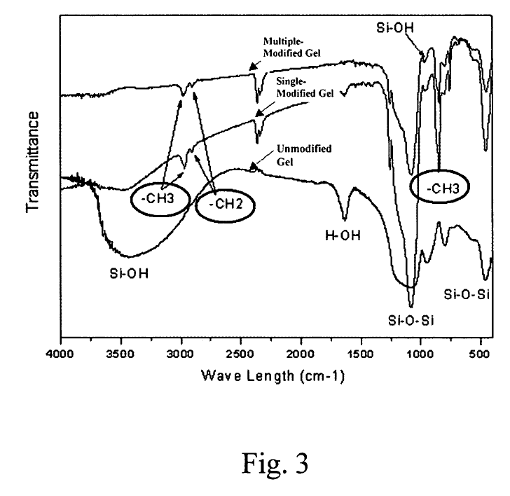

The IR spectrum of the unmodified gel and the modified gels according to Example 1 is shown in FIG. 3, in which the signals of Si—O—Si appear at 1080 cm⁻¹ and 450 c⁻¹, the signals of Si—OH appear at 3450 cm^{—1}, and 965 cm⁻¹, the signals of CH₃ of Si(CH₃)₃O— appear at 2980 cm⁻¹ and 845 cm⁻¹, and the signal of H—OH appears at 1632 cm⁻¹. As the arrows shown in FIG. 3, the unmodified gel has signals at 3450 cm⁻¹ and 965 cm⁻¹ (from Si—OH groups), also has an obvious signal at 1632 cm⁻¹ (from H—OH groups), but it has no signal at 2980 cm⁻¹ and 845 cm⁻¹ (from CH₃ groups). These results show that the unmodified gel has Si—OH groups and H—OH groups, but it does not have CH₃ groups comprised in the modification agents. On the contrary, when the aerogel is single-modified or multiple modified gel, the signals at 3450 cm⁻¹ and 965 cm⁻¹ (from Si—OH groups) disappear as the number of times for modification increases, the signals at 2980 cm⁻¹ and 845 cm⁻¹ from CH₃ of Si(CH₃)₃O— appear as the number of times for modification increases, and the signals at 1080 cm⁻¹ and 450 cm⁻¹ from Si—O—Si become more obvious. These changes show that the hydrophilic groups of modified aerogels have been exchanged with hydrophobic groups.

In addition, the H—OH signal, which represents that water is comprised in the gel, appears in unmodified aerogel, but not appear in single-modified or multiple-modified aerogel. This shows that the water content in the modified aerogels is extreme low.

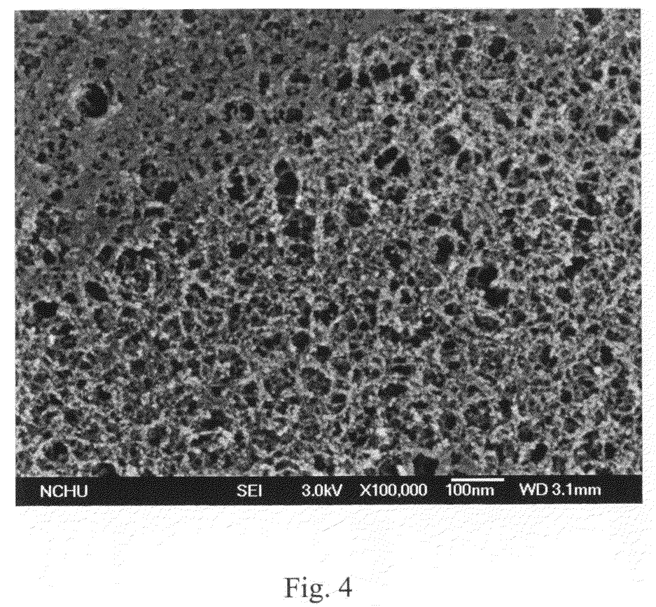

The pore and pore size of the modified gel according to Example 1 are shown in FIG. 4. This shows that the modified aerogel has a complete porous structure, and the problem that the structure of the conventional aerogel collapses is resolved. From above, we know that the surface tension can be effectively decreased by surface modification technology that modifies the hydrophilic groups on the surface of the wet gel to hydrophobic groups, thereby the dried aerogel can maintain a complete three-dimensional network structure.

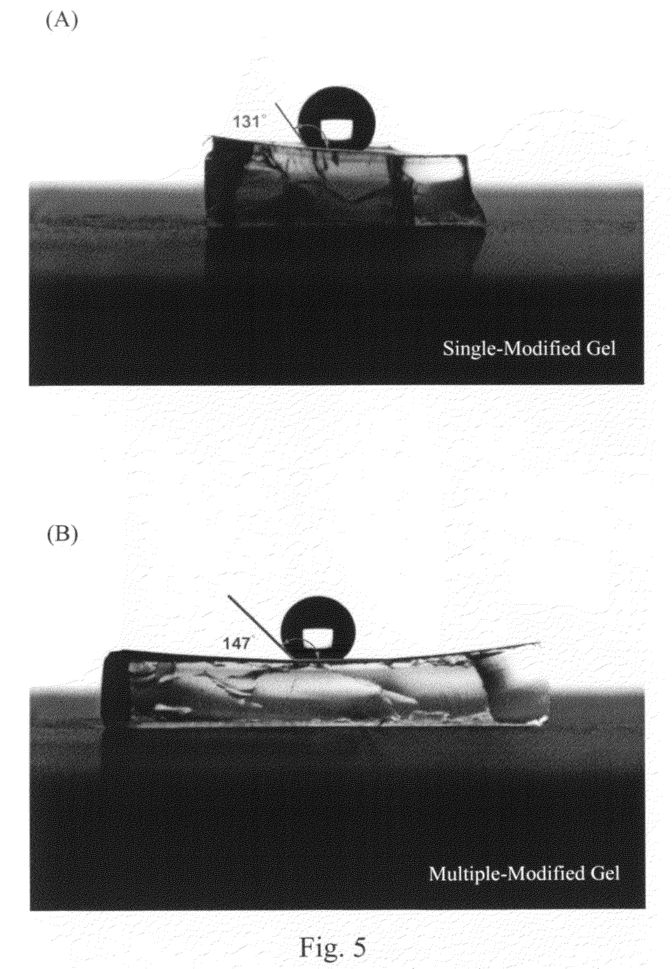

To understand the difference of thermal conductivity between the single-modified and multiple-modified aerogel, the hydrophobic angle test is preceded, and the results are shown in Table 2 and FIG. 5. In FIG. 5, (A) shows the contact angle of a single-modified aerogel and (B) shows the contact angle of a multiple-modified aerogel. When the number of times for modification increases, the thermal conductive coefficient will decrease and the contact angle becomes larger which means hydrophobic increases. This can explain why the multiple-modified aerogel having higher hydrophobicity makes the contact angel increase.

TABLE 2

| | | Disperse | | Contact |
|---|---|---|---|---|
| | Thermal conductive | part | Polar part | angle |
| Item | coefficient (W/m-K) | (mN/m) | (mN/m) | (°) |
| Single- | 0.079 | 17.70 | 0.88 | 131 |
| Modified Gel | | | | |
| Multiple- | 0.030 | 9.60 | 1.77 | 147 |
| Modified Gel | | | | |

In summary, the present invention uses modification agents, e.g. trimethylchlorosilane, to modify the hydrophilic groups on the surface of the aerogel to hydrophobic groups, thereby the surface tension decreases and the gel maintains a complete three-dimensional network structure in the drying step. Therefore, the porous material produced by the process of the present invention has low density, low thermal conductive coefficient, high porosity, high hydrophobicity, and the like, and it has excellent effect for being used as heat insulating materials, heat preservation materials, dew-preventing materials, fireproof materials, corrosion resistant materials.

Although the preferred Examples of the present invention are disclosed above, but they are not used to limit the scope of this invention. Various alterations and modification can be done by those skilled in the art without departing from the spirit and the scope of this invention. The scope of the present invention is defined by the appended claims.

### Other Embodiments

The present invention is specifically described in the above-mentioned Examples, and various alterations and modification can be done without departing from the spirit and the scope of this invention by those skilled in the art according their needs. Therefore, other embodiments are also included in the scope of this invention.

What is claimed is:

1. A porous structure material, which is synthesized by mixing an alkyl siloxane compound or a silicate compound with an organic solvent through a sol-gel process, and modified by modification agents; wherein said modification agents comprises a mixture of trimethylchlorosilane/n-hexane or a mixture of dimethylchlorosilane/n-hexane, and said porous structure material has average thermal conductive coefficient of 0.04 W/m-K to 0.02 W/m-K.

2. The porous structure material according to claim 1, wherein the surface of said porous structure material comprises hydrophobic groups.

3. The porous structure material according to claim 1, wherein the mixing ratio of the alkyl siloxane compound or the silicate compound to the organic solvent is 1:6 to 1:10.

4. The porous structure material according to claim 1, wherein the bulk density of said porous structure material is higher than 0.069 g/cm³.

5. The porous structure material according to claim 1, wherein the porosity of said porous structure material is higher than 95%.

6. A method for manufacturing a porous structure material, which comprises:
(a) mixing an alkyl siloxane compound or a silicate compound with an organic solvent;
(b) adding acidic catalyst to proceed hydrolysis reaction;
(c) adding basic catalyst to proceed condensation reaction, and forming a sol;
(d) washing said sol by a solvent;
(e) exchanging the solvent within said sol with an organic solvent;
(f) adding modification agents to modify the surface of said sol, in which said modification agents comprise a mixture of trimethylchlorosilane/n-hexane or a mixture of dimethylchlorosilane/n-hexane;
(g) removing the modification agents within said sol; and
(h) drying the sol in step (g) to produce a porous structure material.

7. The method according to claim 6, wherein the alkyl siloxane compound in step (a) comprises tetraethoxysilane or tetramethoxysilane.

8. The method according to claim 6, wherein the organic solvent in step (a) comprises ethanol, isopropanol, acetone, methanol, formamide, or ethylene glycol.

9. The method according to claim 6, wherein the mixing ratio of the alkyl siloxane compound or the silicate compound to the organic solvent in step (a) is 1:6 to 1:10.

10. The method according to claim 6, wherein the acidic catalyst in step (b) comprises hydrochloric acid, nitric acid, or oxalic acid.

11. The method according to claim 6, wherein the basic catalyst in step (c) comprises ammonium hydroxide.

12. The method according to claim 6, wherein the solvent in step (d) comprises ethanol, isopropanol, acetone, methanol, formamide, or ethylene glycol.

13. The method according to claim 6, wherein the organic solvent in step (e) comprises n-hexane or heptane.

14. An applicable material comprising the porous structure material according to claim 1, which is used for coating agent, filling material, and heat insulating material.

15. The applicable material according to claim 14, which has bulk density of higher than 0.069 g/cm³.

16. The applicable material according to claim 14, which has porosity of higher than 95%.

17. The applicable material according to claim 14, which has average thermal conductive coefficient of 0.04 W/m-K to 0.02 W/m-K.
